(19) United States
(12) Patent Application Publication
(10) Pub. No.: US 2026/0243720 A1
(43) Pub. Date: Aug. 20, 2026

(54) FIBER / NANOMATERIAL COMPOSITE MESH SENSOR

(71) Applicants: Dae Han Sung, Newark, DE (US); Erik T. Thostenson, Newark, DE (US)

(72) Inventors: Dae Han Sung, Newark, DE (US); Erik T. Thostenson, Newark, DE (US)

(21) Appl. No.: 19/153,815

(22) PCT Filed: Feb. 5, 2024
(86) PCT No.: PCT/US2024/014443

§ 371 Date: Aug. 5, 2025

Related U.S. Application Data
(60) Provisional application No. 63/443,593, filed on Feb. 6, 2023.

(51) Int. Cl. G01N 27/12

(52) U.S. Cl. CPC G01N 27/127

(57) ABSTRACT

Mesh sensors and processes for manufacturing mesh sensors are disclosed. One mesh sensor includes a fabric substrate and metal oxide nanoparticles. The fabric substrate is coated with carbon nanotubes. The metal oxide nanoparticles are deposited on the coated fabric substrate. The mesh sensor is configured to measure a property based upon a change in electrical resistance of the coated fabric substrate. One method for manufacturing a mesh sensor includes coating a fabric substrate with carbon nanotubes by electrophoretic deposition, and depositing metal oxide nanoparticles on the coated fabric substrate.

### CROSS-REFERENCE TO RELATED APPLICATIONS

This application claims priority to U.S. Patent Application No. 63/443,593, entitled “FIBER/NANOMATERIAL COMPOSITE MESH SENSOR,” filed Feb. 6, 2023, the contents of which are incorporated herein by reference in their entirety.

### STATEMENT REGARDING FEDERALLY SPONSORED RESEARCH

This invention was made with government support under contract no. CCMT372153 awarded by Advanced Research Projects Agency—Energy of the U.S. Department of Energy pursuant to the ARPA-E iWRAP program. The government has certain rights in the invention.

### TECHNICAL FIELD

The present invention relates generally to sensors, and more particularly, to functionalized carbon nanotube sensors.

### BACKGROUND

In conventional applications, gas detectors can be used to monitor narrow or small places where combustible gases, poisonous gases, and oxygen shortages might endanger residents or workers. Conventionally, gas sensors are point or quasi-point sensors with a complex detecting mechanism that can only monitor the localized gas composition. Thus, for applications on large infrastructures such as gas pipelines and pressure vessels, a number of sensors need to be placed, and signal processing becomes complex. There remains a need for improvements in sensing systems for such large-scale and other applications.

### SUMMARY

Aspects of the present invention are directed to mesh sensors and processes for manufacturing the same.

In accordance with one aspect of the present invention, a mesh sensor includes a fabric substrate and metal oxide nanoparticles. The fabric substrate is coated with carbon nanotubes. The metal oxide nanoparticles are deposited on the coated fabric substrate. The mesh sensor is configured to measure a property based upon a change in electrical resistance of the coated fabric substrate.

In accordance with another aspect of the present invention, a method for manufacturing a mesh sensor includes coating a fabric substrate with carbon nanotubes by electrophoretic deposition, and depositing metal oxide nanoparticles on the coated fabric substrate.

### BRIEF DESCRIPTION OF THE DRAWINGS

The invention may be best understood from the following detailed description when read in connection with the accompanying drawings, with like elements having the same reference numerals. When a plurality of similar elements are present, a single reference numeral may be assigned to the plurality of similar elements with a small letter designation referring to specific elements. When referring to the elements collectively or to a non-specific one or more of the elements, the small letter designation may be omitted. In addition, according to common practice, the various features of the drawings are not drawn to scale unless otherwise indicated, and the dimensions of the various features may be expanded or reduced for clarity. Included in the drawings are the following figures:

FIG. 1 is a diagram of a mesh sensor according to an example of the invention.

FIG. 2 is a scanning electron micrograph image of a coated fabric substrate of a mesh sensor according to an example of the invention.

FIG. 3 is an image of a roll of a coated fabric substrate for a mesh sensor according to an example of the invention.

FIG. 4 is a diagram of a mesh sensor embedded in a pipe according to an example of the invention.

FIG. 5 is a diagram of a system for manufacturing a mesh sensor according to an example of the invention.

FIG. 6 is a block diagram of a method for manufacturing a mesh sensor according to an example of the invention.

### DETAILED DESCRIPTION

The devices, systems, and methods disclosed herein relate to mesh sensors. The disclosed mesh sensors may be particularly suitable for forming a large-scale distributed sensor by depositing different functionalized nanomaterials onto a lightweight fabric network. The nanomaterials deposited can include, in some preferred examples, multi-walled carbon nanotubes and metal oxide nanospheres. The use of fiber-based textiles as a substrate material may enable the creation of a distributed sensor capable of monitoring a large area unlike conventional gas sensors which provide localized point or quasi-point signals. The large-scale sensors can be embedded into structures like oil/gas pipelines, pressure vessels, automobiles, and building walls to detect gas leakage and monitor structural-health. The mesh-like structure is also applicable to composites manufacturing with ultra-violet (UV) curing resin systems.

In one example, a mesh sensor according to aspects of the invention comprises a carbon-nanotube-coated fabric with metal oxide nanoparticles deposited thereon. A pair of tap points can be coupled to the carbon-nanotube-coated fabric, with the pair of tap points separated from one another such that they have a measurable electrical resistance therebetween. The mesh sensors described herein can be configured to measure a property of a structure in which the nanotube-coated fabric with metal-oxide-nanoparticles is embedded, a property of a gas in contact with the nanotube-coated fabric with metal-oxide-nanoparticles, or a combination thereof, based upon changes in the electrical resistance between the pair of tap points.

In some examples, the metal oxide nanoparticles may comprise tin oxide (SnO₂), copper oxide (CuO), or a combination thereof, but is not limited to any particular substance. In some examples, the nanoparticles may have a diameter of less than 50 nm.

In some examples, the gas to be measured is water, such that the mesh sensor acts as a humidity sensor. In other examples, the gas to be measured is a hydrocarbon, such as methane, and the mesh sensor may be configured to measure concentrations of gas in a pipeline.

In some examples, the mesh sensor may be embedded as a layer in a resin infused laminate, such as wherein the resin is a UV-cured resin. In such laminates, the mesh sensor may be defined by a plurality of sensor layers, each sensor layer comprising a nanotube-coated fabric with metal-oxide-nanoparticles, wherein a difference in a reading of a first sensor layer relative to a second sensor layer provides a signal proportional to a desired property to be measured corresponding to a geometry of the plurality of sensor layers, a gas in contact with one or more of the sensor layers, or a combination thereof. A first gas sensor layer may be separated from a second gas sensor layer by one or more non-sensor layers, such as when the plurality of sensor layers and non-sensor layers form a resin infused laminate embedded in the sidewall of a cylindrical pipe.

In laminate pipe examples, the first sensor layer may be disposed so that at least a first tap point located in a first portion of the first sensor layer is positioned diametrically opposed to at least a second tap point located in a second portion of the first sensor layer, and the second sensor layer may be disposed so that at least a third tap point located in a first portion of the second sensor layer is positioned diametrically opposed to at least a fourth tap point located in a second portion of the second sensor layer. These example sensors may be used to measure properties such as hoop stress of the pipe, axial stress or strain of the pipe, and gas concentration of gas in the pipe, including detecting leaks in the pipe.

The carbon-nanotube-coated fabric may be, for example, be a device or product of processes and methods as described in U.S. Published Patent Application Publication No. US20200180264A1, titled CARBON NANOTUBE BASED SENSOR, incorporated herein by reference in its entirety. In one preferred example, the carbon-nanotube-coated fabric comprises a random veil with an areal density of 10 g/m2 coated with a sufficient quantity of carbon nanotubes to form a baseline electrical resistance in a range of 100 to 300 kΩ, and the metal oxide comprises SnO₂ nanoparticles having a diameter of less than 50 nm that are electrophoreticly deposited. The example mesh sensor exhibits a change in electrical resistance in response to a change in a concentration of gas, e.g. due to adsorption of gas molecules on the metal oxide nanoparticles, that is one to four times greater than a change in electrical resistance measured in response to the same change in concentration of gas by a carbon-nanotube-coated fabric in the absence of the metal oxide nanoparticles.

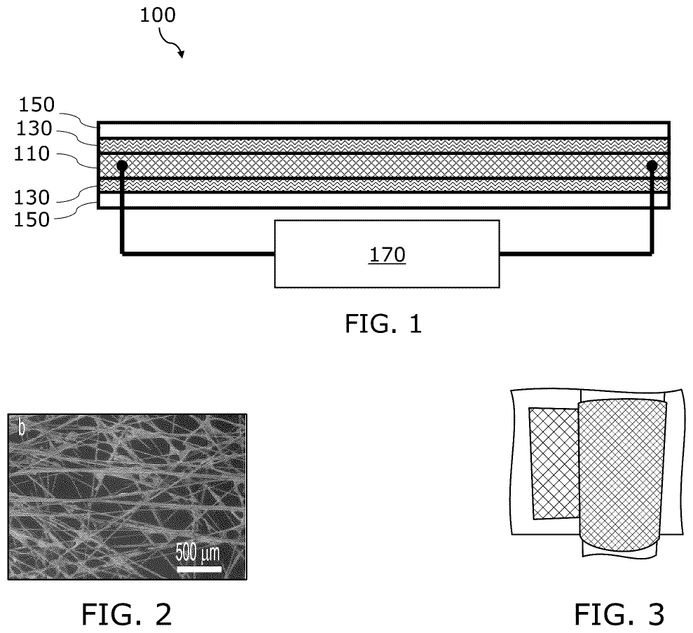

With reference to the drawings, FIG. 1 illustrates an example mesh sensor 100. Mesh sensor 100 may be configured for use in sensing a property of a gas in which sensor 100 is positioned, or a property of a structure in which sensor 100 is embedded. As an example, mesh sensor 100 includes a fabric substrate 110, a layer of carbon nanotubes 130, and a layer of nanoparticles 150. Additional details of this mesh sensor 100 are set forth below.

The fabric substrate 110 serves as the base or support for the functional layers of sensor 100. Fabric substrate 110 may be a woven or unwoven fabric. Fabric substrate 110 may have aligned or random fibers. Fabric substrate 110 may preferable be formed with relatively opening area or low density, e.g. using fabric having an areal density of 10-20 g/m². The size (e.g. length or width) of fabric substrate 110 may be selected based on the intended application of sensor 100, or on the area to be sensed by sensor 100. As one example, fabric substrate 110 may be provided on rolls 15 cm wide, and 10 m long. In some examples, fabric substrate 110 is a fiberglass fabric. However, other materials may be used for forming fabric substrate 110 without departing from the scope of the invention. Suitable fiberglass fabrics for use as substrate 110 will be known from the description herein, and include E-glass fiber veils supplied by Technical Fibre Products, Inc.

Fabric substrate 110 is coated with a layer of carbon nanotubes 130. As shown in FIG. 1, fabric substrate 110 may include a coating of carbon nanotubes 130 on both upper and lower surfaces thereof. Alternatively, fabric substrate 110 may be coated on one size with carbon nanotubes 130. Carbon nanotubes 130 may be single-walled or multi-walled carbon nanotubes. In some examples, carbon nanotubes 130 may be polyethyleneimine-functionalized carbon nanotubes. Treating carbon nanotubes with ozone and/or polyethyleneimine (PEI) prior to deposition may give the carbon nanotubes a positive change, promoting deposition on fabric substrate 110 through electrophoresis using a DC power source.

Nanoparticles 150 are deposited on the layer of carbon nanotubes 130. In some examples, nanoparticles 150 may be metal oxide nanoparticles, such as tin oxide (SnO₂) or copper oxide (CuO). Other metal oxide nanoparticles, or other types of nanoparticles, may be used. It will be understood that that any other functionalizing particle (including but not limited to other metal oxides) that are known or found to be selective for a particular analyte of interest may be used as nanoparticles 150. Nanoparticles 150 may have any size arising from the manner in which they are deposited on carbon nanotubes 130. In some examples, nanoparticles 150 have a diameter of 50 nm or less.

FIG. 2 shows a micrographic image of a random fiberglass fabric substrate coated with multi-walled carbon nanotubes and metal oxide nanoparticles. As shown in FIG. 3, the fabric substrate may be manufactured and/or stored as a roll of coated/functionalized fabric, which can be cut and formed to the particular sensing application of interest.

In use, the coated fabric substrate has an electrical resistance due at least in part to the coating of carbon nanotubes and/or nanoparticles. The resistance across two points (e.g. tap points for electrical wiring) on the coated fabric may be measured, characterized, and monitored during sensing applications. The mesh sensors according to aspects of the invention are configured to measure a physical or chemical property of the surroundings based upon a change in resistance of the coated fabric substrate.

In some examples, the mesh sensor may be positioned in contact with a gas. For one example, nanoparticles may be selected that are known or configured to adsorb water, enabling the mesh sensor acts as a humidity sensor. For another example, nanoparticles may be selected that are known or configured to adsorb certain hydrocarbon molecules, such as methane. In such examples, the resistance of the coated fabric may change due to adsorption of a particle of interest from the gas by the carbon nanotubes and/or nanoparticles. Thus, mesh sensor 100 may be configured to detect a content or concentration of an analyte in the gas based on the change in resistance of the coated fabric substrate.

In other examples, the mesh sensor may be embedded in a structure. In such examples, the resistance of the coated fabric may change due to physical changes in the fabric itself, e.g. from stretching, tearing, twisting, etc., arising from changes to the structure in which the sensor is embedded. Thus, mesh sensor 100 may be configured to detect a tensile or physical property of the structure based on the change in resistance of the coated fabric substrate.

Mesh sensor 100 may include additional components associated with monitoring changes in resistance of the fabric substrate 110 coated with carbon nanotubes 130 and nanoparticles 150. As one example, mesh sensor 100 may include one or more electronic components 170 coupled to fabric substrate 110 and configured to detect changes in resistance across the coated fabric. Electronic components 170 may include a power source, e.g. a voltage or current source, wiring, resistors, and/or electrodes. Electronic components 170 may also include one or more voltage detectors, current detectors, processors, and or memories for monitoring and storing measurements of resistance across the coated fabric. Suitable electrical circuits and components for measuring and monitoring changes to the resistance of the coated fabric will be apparent from the description herein.

Where mesh sensor 100 is configured to adsorb water molecules, electronic components 170 may monitor changes in resistance of mesh sensor 100 to detect a water content of the gas. Where mesh sensor 100 is configured to adsorb hydrocarbon molecules, electronic components 170 may monitor changes in resistance of mesh sensor 100 to detect a concentration of the hydrocarbon in the gas.

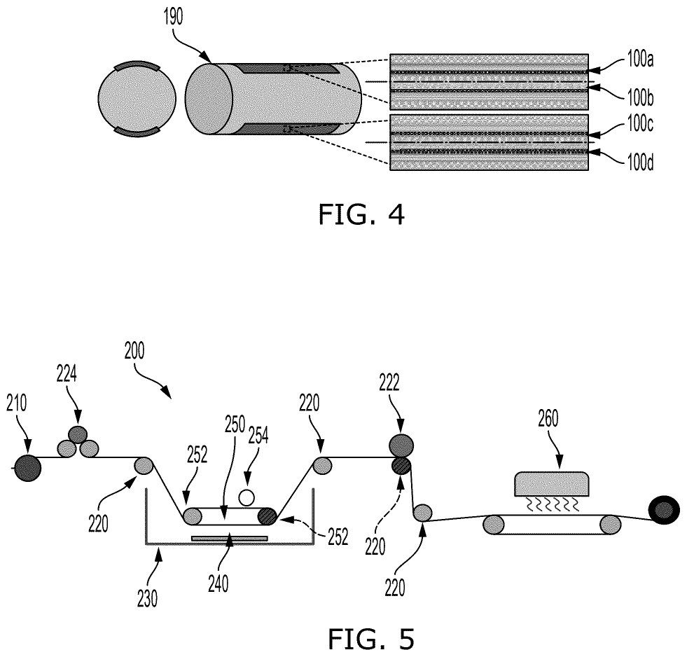

As noted above, mesh sensor 100 may be embedded in a structure 190. As shown in the example of FIG. 4, mesh sensor 100 may be embedded as a layer in a laminate, such as the sidewall of a cylindrical pipe. The materials of mesh sensor 100 may make the sensor particularly suitable for use as a layer in a UV-cured resin laminate.

Mesh sensor 100 is not limited to a single coated fabric substrate. As shown in FIG. 4, mesh sensor 100 may comprise a plurality of sensor layers 100a-100d, each layer having its own fabric substrate 110 coated with carbon nanotubes 130 and nanoparticles 150. This example depicts a schematic diagram of a potential sensing strategy applicable to the structural health monitoring of composite pipelines using distributed large-area sensors. As shown in FIG. 4, two mesh sensor pairs are provided on the top and bottom laminates, respectively, and the two layers of each pair are distanced away from the midplane of a laminate. Tap points (e.g., for connecting electrical wires for measuring resistance across the sensor pairs) may be positioned at ends of the pipe or at intervals along a length of the pipe. Such tap points may be axially aligned, staggered, or opposed, depending on the desired sensing application. This configuration of distributed sensors is designed to be able to detect different modes of deformation that the pipeline possibly experiences. For example, the top and bottom pairs of sensors will exhibit the opposite directional resistance change under the axial stress such as sagging, bending and deflection, resulting from the tension or compression. However, if the pipeline is deformed by the hoop stress due to the gas pressure and temperature change, all four layers will show a similar resistance change. It is expected that the manipulation of nanomaterials and sensor configurations will enable obtaining additional structural integrity-related information such as crack growth status, the location of gas leakage and the timing for rehabilitation.

In gas sensing applications where multiple mesh sensors 100 are used, the nanoparticles 150 of one sensor layer may be selected to be different from the nanoparticles 150 of another sensor layer where it is desired that mesh sensor 100 be sensitive to more than one analyte. In some examples, each layer of mesh sensor 100 may be selected to sense a particular analyte of interest.

When embedded in a structure, various layers of mesh sensor 100 may be separated from one another by one or more non-sensor layers. For example, sensor layers may be insulated from one another to ensure that changes in resistance of one sensor layer do not affect resistance measurements for another sensor layer.

FIG. 5 illustrates an example system 200 for manufacturing a mesh sensor. System 200 may be usable for manufacturing mesh sensor 100. As an example, system 200 includes a fabric roll 210, rollers 220, a processing bath 230, and electrodes 240 and 250. Additional details of this system 200 are set forth below.

Fabric roll 210 provides a source of uncoated fabric. In an example, fabric roll 210 is a roll of fabric substrate 110. Fabric roll 210 is configured to unroll as the fabric substrate 110 is processed during manufacturing of mesh sensor 100. Fabric substrate 110 may be rolled during manufacturing thereof, or may be create from previously manufactured fabric substrate 110.

Rollers 220 convey the fabric through the manufacturing process. In an example, rollers 220 unspools fabric substrate 110 from folder roll 210 during manufacturing. Rollers 220 may be idle or drive rollers, or may include a combination thereof. At least one driven roller 222 may be a nipping roller in order to draw fabric substrate from fabric roll 210 through processing bath 230. The driven nipping roller 220 may be driven by a motor coupled to a controller, in order to enable a user to control and/or adjust the pace of unrolling and processing of fabric substrate 110. Fabric substrate 110 may be fed through processing bath 230 at a speed of 10-50 cm/min or more, depending on the length of processing bath 230 and other variables of the electrophoresis process. Rollers 220 may further include a tensioning roller 224 configured to hold fabric substrate 110 under tension during all or a portion of the manufacturing process.

Processing bath 230 provides an environment for treatment and coating of the fabric. In an example, fabric substrate 110 is coated with carbon nanotubes 130 through electrophoretic deposition. Processing bath 230 provides a liquid bath containing carbon nanotubes which may be treated with ozone and/or polyethyleneimine (PEI) to give the carbon nanotubes a positive change. In one example, processing bath 230 contains carbon nanotubes at a concentration of 0.5-5.0 g/L. Fabric substrate 110 may spend from 5 -25 minutes within processing bath 230 for each coating pass. One or multiple coating passes may be performed for each side of fabric substrate 110. Other elements of processing bath 230 for promoting electrophoretic deposition will be known from the description herein.

Processing bath 230 further includes electrodes 240 and 250 for applying an electrical bias to the carbon nanotubes 130. In an example, electrode 240 is a static electrode provided at the bottom of processing bath 230. Electrode 240 may be positively charged, in order to bias positively-charged carbon nanotubes upward toward fabric substrate 110. Electrodes 240 and 250 may generate an electric field having a strength in the range of 10-20 V/cm for creating electrophoresis. One or both of electrodes 240 and 250 may have variable heights in order to adjust the electric field strength therebetween. Suitable conductive materials for use as electrode 240 will be known from the description herein.

In a preferred example, electrode 250 is a non-static or rolling electrode. Electrode 250 is maintained in direct contact with fabric substrate 110. Such direct contact may be a slipping or non-slipping contact. For example, electrode 250 can be arranged as a conveyer belt rolling at the same speed rollers 220, such that points of contact between electrode 250 and fabric substrate 110 are maintained as fabric substrate 110 moves through processing bath 230, and slipping of fabric substrate 110 relative to electrode 250 is prevented. The rolling speed of electrode 250 may be controlled using one or more driver rollers 252, which operate in concert with rollers 220 to convey fabric substrate 110 through processing bath 230.

Contact between electrode 250 and fabric substrate 110 may be maintained through the use of at least one tensioner 254. Tensioner 254 may be formed as a rigid metal rod placed in contact with electrode 250 to urge electrode 250 in contact with fabric substrate 110. In some examples, a tensioner 254 applies tension to rolling electrode 250 to maintain contact between fabric substrate 110 and rolling electrode 250. In a preferred example, the tensioner 254 may also be used to apply DC power to the rolling electrode 250 to for the electrophoresis. Electrical power may be applied to tensioner 254 by any known process, including for example a slip-ring connection.

Electrode 250 may comprise a flexible, rollable strip of conductive material mounted on one or more rollers 252. In one example, electrode 250 may be formed as a loop of conductive material which is wound in a circuit around multiple rollers 252. In this example, at least one roller 252 may be driven by a motor coupled to a controller, in order to enable a user to control and/or adjust the pace of rolling of electrode 250 to correspond to the pace of conveying of fabric substrate 110.

In a preferred example, electrode 250 may be formed from perforated or meshed conductive material. It will be understood that, during the application of DC power to the processing bath to produce electrophoresis, one or more air bubbles may be formed, e.g. due to electrolysis. These air bubbles will naturally rise through the bath liquid due to their buoyancy, where they may come into contact with fabric substrate 110 and/or rolling electrode 250. To promote coating of fabric substrate 110 with carbon nanotubes 130, it may be helpful to promote the escape of air bubbles from processing bath 230, to prevent such air bubbles from forming a barrier between fabric substrate 110 and carbon nanotubes 130, or between fabric substrate 110 and electrode 250. To this end, the use of a perforated or meshed conductive material as electrode 250 may promote escape of air bubbles, thereby improving coating of fabric substrate 110 with carbon nanotubes 130. In some examples, electrode 250 may be a perforated stainless-steel mesh having a mesh size of open area of 50-70%, a mesh opening size of 0.600 mm or more.

System 200 may further include a dryer 260 positioned downstream of processing bath 230. Dryer 260 may be operated to dry the fabric substrate 110 after it has been coated with carbon nanotubes 130, to promote adhesion of carbon nanotubes 130 and/or to prepare the coated fabric for storage. In some examples, dryer 260 may employ one or more compressed air nozzles to dislodge excess liquid from processing bath 230. In some examples, dryer 260 may employing one or more infrared heat sources to promote drying of material remaining on fabric substrate 110. Other suitable apparatus for drying the coated fabric will be known from the description herein.

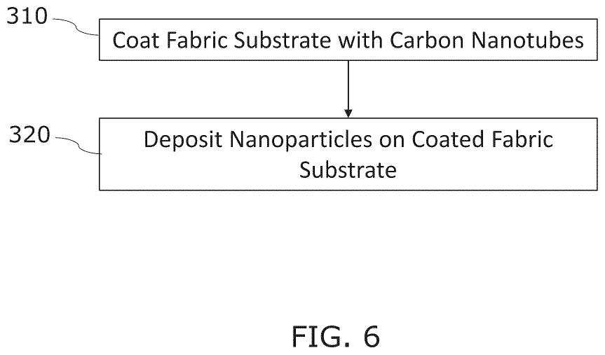

FIG. 6 illustrates an example method 300 for manufacturing a mesh sensor. Method 300 may be usable for manufacturing mesh sensor 100. As an example, method 300 includes a step 310 of coating a fabric substrate with carbon nanotubes, and a step 320 of depositing nanoparticles on the coated fabric substrate. Additional details of this method 300 are set forth below.

In step 310, a fabric substrate is coated with carbon nanotubes by electrophoretic deposition. In an example, fabric substrate 110 is coated with carbon nanotubes 130 by electrophoretic deposition in processing bath 230, as described above with respect to system 200. Fabric substrate 110 may be conveyed through processing bath 230 due to contact with rollers 220 and/or rolling electrode 250.

In step 320, nanoparticles are deposited on the coated fabric substrate. In an example, nanoparticles 150 such as metal oxide nanoparticles are deposited on the fabric substrate 110 coated with the carbon nanotubes 130. Nanoparticles 150 may be deposited through any known process including, for example, physical vapor deposition.

Method 300 is not limited to the above steps. In some examples, method 300 may include a step of applying a tensioner to the rolling electrode to maintain the contact between the fabric substrate and the rolling electrode. In a preferred example, this step may further include applying electrical power to the rolling electrode via the tensioner. As explained above with respect to system 200, a tensioner 254 may be provided with electrode 250 to (i) help maintain contact between fabric substrate 110 and electrode 250, and (ii) convey electrical power from a power source to rolling electrode 250.

Although the invention is illustrated and described herein with reference to specific embodiments, the invention is not intended to be limited to the details shown. Rather, various modifications may be made in the details within the scope and range of equivalents of the claims and without departing from the invention.

1. A mesh sensor comprising:
a fabric substrate coated with carbon nanotubes; and
metal oxide nanoparticles deposited on the coated fabric substrate,
wherein the mesh sensor configured to measure a property based upon a change in electrical resistance of the coated fabric substrate.

2. The mesh sensor of claim 1, wherein the fabric is a fiberglass fabric.

3. The mesh sensor of claim 1, wherein the carbon nanotubes comprise multi-walled carbon nanotubes.

4. The mesh sensor of claim 1, wherein the carbon nanotubes are polyethyleneimine-functionalized carbon nanotubes.

5. The mesh sensor of claim 1, wherein the metal oxide nanoparticles comprise copper oxide, tin oxide, or a combination thereof.

6. The mesh sensor of claim 1, wherein the metal oxide nanoparticles have a diameter less than 50 nm.

7. The mesh sensor of claim 1, wherein the mesh sensor is embedded as a layer in a laminate.

8. The mesh sensor of claim 7, wherein the laminate comprises a UV-cured resin laminate.

9. The mesh sensor of claim 1, wherein the mesh sensor comprises a plurality of sensor layers, each sensor layer comprising a fabric substrate coated with carbon nanotubes and metal oxide nanoparticles deposited on the coated fabric substrate.

10. The mesh sensor of claim 9, wherein a first sensor layer of the plurality of sensor layers is separated from a second sensor layer of the plurality of sensor layers by one or more non-sensor layers.

11. The mesh sensor of claim 1, further comprising one or more electronic components coupled to the coated fabric substrate and configured to detect the change in electrical resistance of the coated fabric substrate.

12. The mesh sensor of claim 11, wherein the mesh sensor is embedded in a structure, and the one or more electronic components are configured to detect a tensile property of the structure based on the change in electrical resistance of the coated fabric substrate.

13. The mesh sensor of claim 11, wherein the mesh sensor is in contact with a gas, and the one or more electronic components are configured to detect a content of the gas based on the change in electrical resistance of the coated fabric substrate.

14. The mesh sensor of claim 13, wherein the one or more electronic components are configured to detect a water content of the gas.

15. The mesh sensor of claim 13, wherein the gas comprises a hydrocarbon, and the one or more electronic components are configured to detect a concentration of the hydrocarbon in the gas.

16. A method for manufacturing a mesh sensor, comprising the steps of:
coating a fabric substrate with carbon nanotubes by electrophoretic deposition; and
depositing metal oxide nanoparticles on the coated fabric substrate.

17. The method of claim 16, wherein the coating comprises conveying the fabric substrate through a processing bath in contact with a rolling electrode.

18. The method of claim 17, wherein the rolling electrode is a perforated or mesh electrode.

19. The method of claim 17, further comprising applying a tensioner to the rolling electrode to maintain the contact between the fabric substrate and the rolling electrode.

20. The method of claim 19, further comprising applying electrical power to the rolling electrode via the tensioner.
